(19) United States
(12) Patent Application Publication
(10) Pub. No.: US 2009/0057378 A1
(43) Pub. Date: Mar. 5, 2009

(54) IN-SITU CHIP ATTACHMENT USING SELF-ORGANIZING SOLDER

(76) Inventors: Chi-Won Hwang, Tsukuba (JP); Daewoong Suh, Phoenix, AZ (US)

Correspondence Address: INTEL CORPORATION;c/o INTELLEVATE, LLC, P.O. BOX 52050, MINNEAPOLIS, MN, 55402, US

(21) Appl. No.: 11/845,174

(22) Filed: Aug. 27, 2007

(51) Int. Cl. B23K 35/36; B23K 1/00

(52) U.S. Cl. 228/248.1; 148/24

(57) ABSTRACT

An in-situ chip attachment process uses a self-organizing solder paste composed of a synthetic resin organic flux and solder particles having a mean diameter that falls between around 0.1 μm and around 10 μm. The process is carried out by blanket depositing the solder paste on a first substrate having a first metal structure, pressing a second substrate having a second metal structure into the solder paste such that the second metal structure is aligned with the first metal structure and a gap exists between the first and second metal structures, heating the solder paste to a reflow temperature for a time duration sufficient to cause the solder particles to coalesce and form an electrical connection between the first and second metal structures. The reflow temperature ranges from around 100° C. to around 500° C. The time duration ranges between around 30 seconds and around 900 seconds.

### BACKGROUND

In the manufacture of integrated circuits, forming interconnections at a pitch of 100 μm pitch or less has being been one of challenges for next generation package technology. Conventional chip attachment for controlled collapse chip connection (C4) modules is based on the reflow of solder bumps that are pre-formed on a substrate electrode pad. To pre-form the solder bumps, stencil printing techniques may be used to dispense high viscosity solder paste onto the electrode pads through a mask. Unfortunately, for electrode pads having a pitch of 100 μm or less, solder bridges are easily formed due to the narrow gaps that exist between adjacent electrode pads. The solder bridges form an undesired electrical coupling between two or more electrode pads, leading to electrical short circuits. FIG. 1 shows an example of solder paste bridges (circled) that occur just after stencil printing using a conventional metal mask for electrode pads having a 150 μm pitch.

Another technique used to pre-form solder bumps is electroplating, however, this process is complex and expensive due to the need for a photomask and etching processes. Accurately controlling alloy compositions in ternary or higher-order alloy systems can also present problems, especially for small amounts of alloying element in lead-free solders.

Micro solder ball mounting techniques have been developed, however, they are also costly because of the increased number of solder balls needed in finer pitch applications. This technique also requires a pitch of 100 μm or more. Finally, an arrayed solder ball transferring method or a molten solder jetting method has been developed, but such processes are very immature for high volume manufacturing with limited applications.

Accordingly, improved methods of forming electrical interconnections are needed to address bridging issues that occur on electrode pads having pitches of 100 μm or less.

### BRIEF DESCRIPTION OF THE DRAWINGS

FIG. 1 is an image that shows solder bridging between electrode pads that occurs in prior art methods of forming interconnections.

FIGS. 2A to 2F illustrate a prior art method of forming an interconnection.

FIG. 3 illustrates solder particles coalescing onto a metal bump.

FIG. 4 illustrates why solder particles coalesce onto a metal bump.

FIG. 5 illustrates different types of metal structures that may be interconnected with a metal pad using the methods of the invention.

FIG. 6 is a method of forming solder bumps in accordance with an implementation of the invention.

FIGS. 7A to 7C illustrate solder bumps being formed using the method of FIG. 6.

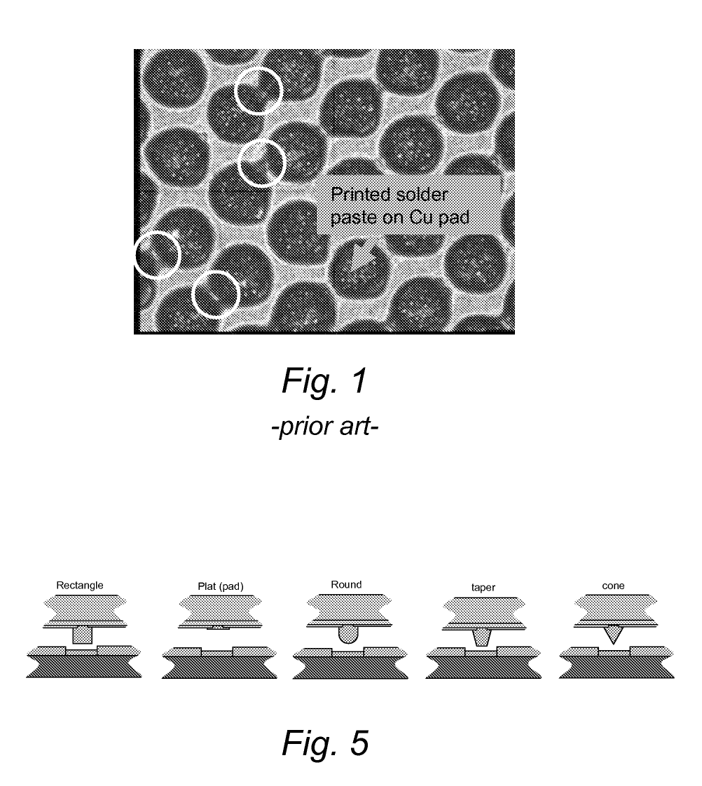

### DETAILED DESCRIPTION

Described herein are systems and methods of forming interconnections between metal bumps on an integrated chip and metal pads on a substrate. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

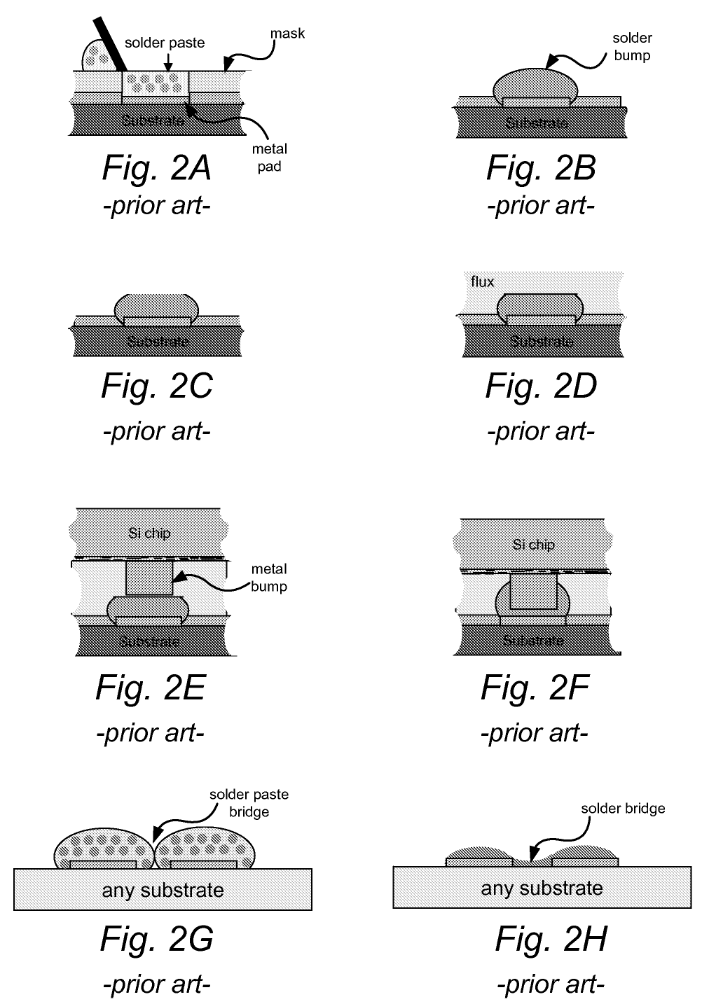

By way of background, FIGS. 2A through 2F illustrate a conventional method of forming interconnections between metal pads on a first substrate and metal bumps on a second substrate. FIG. 2A illustrates a stencil printing technique used to deposit solder paste onto a metal pad of a first substrate. A mask is placed on the substrate and an opening in the mask exposes the metal pad. The solder paste is then deposited onto the metal pad through the opening in the mask. The excess solder paste is removed, as shown in FIG. 2A. The stencil printing process only deposits the solder paste on the surfaces of the metal pads. The gaps between metal pads do not contain solder paste. As such, the solder paste layer is discontinuous.

FIG. 2B illustrates a reflow process used to pre-form a solder bump using solder available in the solder paste. The elevated temperature of the reflow process causes the solder particles in the solder paste to melt and form a solder bump on the metal pad. The solder bumps are “pre-formed” in that they are formed before the first substrate is interconnected with a second substrate. Since the solder bumps are generally formed in an array, solder bumps of varying heights may be formed. Therefore, as shown in FIG. 2C, a leveling process is used to remove a portion of the top of the solder bumps to make them a uniform height. A flux is then applied over the solder bumps, as shown in FIG. 2D, to assist in the formation of interconnections.

Turning to FIG. 2E, a second substrate, here a silicon chip, having a metal bump is placed in contact with the first substrate. As shown, the metal bump makes contact with the solder bump. Finally, as shown in FIG. 2F, a reflow process is carried out to elevate the temperature and cause the solder bump to reflow and surround the metal bump of the second substrate.

As described above, one critical issue with the method described in FIGS. 2A to 2F is that for metal pads or bumps having a pitch of 100 μm or less, solder bridges tend to form between adjacent metal pads. Turning to FIG. 2G, two metal pads having a fine pitch are shown. As such, the gap between the pads is relatively small. When the solder paste is stencil printed onto the pads and the mask is removed, the diameter of the solder paste may expand a bit as it relaxes, causing the solder paste on adjacent pads to contact each other and form a solder bridge. Then during a conventional reflow process, as shown in FIG. 2H, the solder particles may form an undesirable solder bridge between the adjacent pads. Such solder bridges can lead to electrical shorting.

To overcome issues found in conventional processes, implementations of the invention provide a self-organizing solder paste that can form solder interconnections for fine pitch interconnections of less than 100 μm. The self-organizing solder paste of the invention consists of micro solder particles dispersed in an organic flux. The solder paste is molten at reflow temperatures and is wetting on solid interconnection structures. In some implementations, two different types of solder particles may be dispersed in the organic flux to form a solder alloy interconnection.

A solder paste may be formed by combining solder particles and a flux. The solder particles are generally dispersed throughout the flux and tend to randomly travel within the flux at elevated temperatures due to the local convention of liquids in a solder paste.

As will be known to those of skill in the art, flux is a substance that facilitates soldering by chemically cleaning the metals to be joined. For instance, flux may be used to remove and prevent oxidation from the metal surfaces being interconnected, such as the metal bump, the metal pad, and the solder particles. Flux is generally an inert substance at room temperature but becomes strongly reducing at elevated temperatures, thereby preventing the formation of metal oxides. Flux also acts as a wetting agent in soldering processes. Additionally, flux seals out air, which prevents further oxidation.

In implementations of the invention, the flux used to form the solder paste is an organic flux based on a synthetic rosin. In alternate implementations, a synthetic resin may be used. The use of an organic flux enables the solder paste to remove oxidation from the solder particles as well as the metal bumps and metal pads that are being interconnected. Generally, the organic flux will react with and remove oxidation layers at elevated temperatures of around about 100° C. to 200° C. The solder paste may further contain various additives that are well known in the art, including but not limited to surfactants and activators.

The solder particles dispersed in the organic flux may include any metal typically used in solder compositions. For instance, base metals that may be used in the solder particles include, but are not limited to, tin (Sn), indium (In), bismuth (Bi), and zinc (Zn). Furthermore, alloying metals that may be combined with the base metal include, but are not limited to, copper (Cu), nickel (Ni), cobalt (Co), silver (Ag), gold (Au), titanium (Ti), aluminum (Al), lanthanum (La), cerium (Ce), iron (Fe), manganese (Mn), gallium (Ga), germanium (Ge), antimony (Sb), tantalum (Ta), and phosphorous (P). The alloy metal may be added to improve microstructure, mechanical, and thermal properties of the solder particle. In implementations of the invention, the weight percent (wt %) of solder particles in the solder paste may range from around 10 wt % to around 50 wt %, depending on the pitch of the metal pads and the volume of the dispensing solder paste.

The solder paste may include solder particles with different compositions that are dispersed throughout the organic flux. The use of more than one type of solder particle can produce in-situ solder alloys during reflow. For instance, the use of tin-containing solder particles with silver-containing solder particles may produce a SnAg eutectic alloy.

In accordance with implementations of the invention, the mean diameter of the solder particles may range from around 0.1 μm to around 10 μm, but will generally range from around 0.1 μm to around 5 μm. In some implementations, a larger diameter may be used as long as the solder particle is smaller than the gap that exists between adjacent electrode pads to prevent the occurrence of solder bridging. The small size of the solder particles used in the solder paste of the invention relative to conventional solder particles aids in the coalescing of solder on the metal structures and helps minimize the occurrence of solder bridges.

In accordance with implementations of the invention, the self-organizing solder paste of the invention may be applied over an array of metal bumps, such as an array of copper bumps, and a reflow process may be carried out to fabricate an individual solder bump over each copper bump. This process may be carried out without the use of a mask or stencil printing techniques.

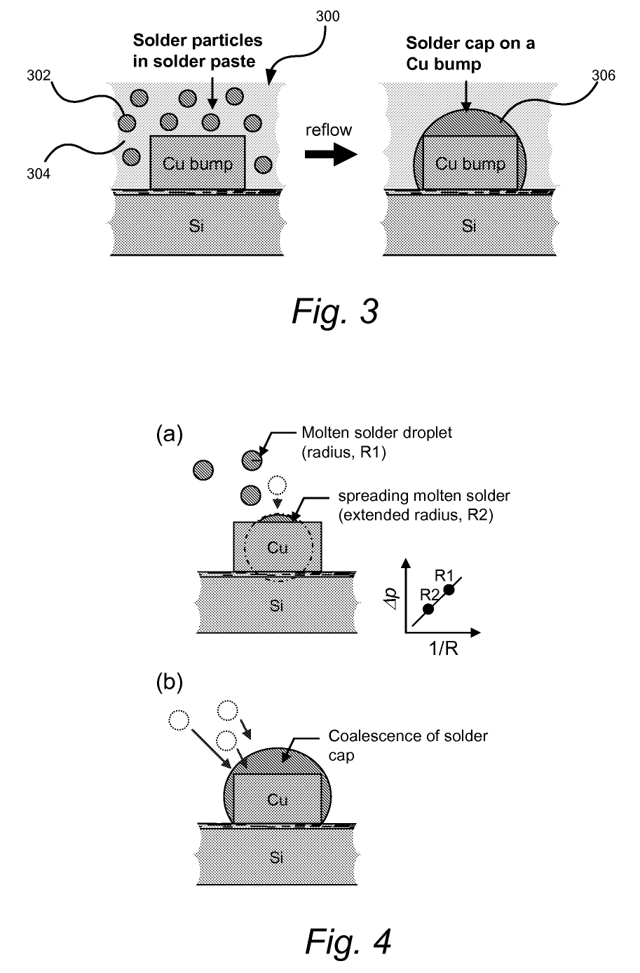

FIG. 3 illustrates how the self-organizing solder paste 300 of the invention is used to form a solder bump over a metal bump, such as a copper bump used on a C4 package. The solder paste 300, having solder particles 302 dispersed within an organic flux 304, is deposited on a copper bump that is mounted on a silicon substrate. A reflow process is then carried out. During reflow, the temperature of the solder paste is elevated to above the melting point of the solder particles but below the melting point of the metal bump. The solder particles 302 become molten and coalesce on the surface of the copper bump, resulting in the formation of a solder bump 306. This self-induced coalescing nature of the solder particles is what is referred to herein as the self-organizing mechanism of the solder paste of the invention. The organic flux remains over the solder bump 306 and is substantially free of solder particles 302.

The following description, which references FIG. 4, is an explanation of what is believed to be the mechanism by which the solder particles become attracted to the metal bump and coalesce on its surface in a self-organizing fashion. This explanation is provided simply for the reference and convenience of those who wish to better understand how the methods of the invention are possible. The following explanation is theoretical in nature and should not be read as explicitly or impliedly imposing limitations or restrictions on the implementations of the invention described herein.

It is believed that the self-organizing mechanism of the solder paste of the invention is based on a series of wetting, spreading, and coalescing processes. For instance, at a temperature that is at or above the melting point of the solder, the solder particles become molten and continue to travel through the flux. As shown in FIG. 4a, when a molten solder particle comes into contact with a metal bump, a sequence of wetting and spreading occurs, forming an intermetallic compound. For example, if the solder is tin-based, the intermetallic compound may be Cu₆Sn₅ or Cu₃Sn. The intermetallic compound tends to be at a thermodynamically stable phase.

Next, as shown in FIG. 4b, coalescence occurs as additional molten solder particles come into contact with the solder that has spread onto the metal bump. The coalescing appears to be driven by the reduction in interface energy and the reduction in internal Laplace pressure that occurs as the solder particles combine and spread. The interface Gibbs free energy for a molten particle is given by:

ΔG=γ3V/R

In the above equation, γ represents the surface energy of the molten solder particle, V represents the molar volume of the solder particle, and R represents the radius of the particle. As shown, the interface Gibbs free energy (ΔG) decreases as the radius of the particle increases. Accordingly, two solder particles can be easily combined to form a larger particle, thereby decreasing the interface Gibbs free energy.

Similarly, the Laplace pressure within a particle is given by:

Δp=γ2/R

Here, γ again represents the surface energy of the molten solder particle and R represents the radius of the particle. As with the interface Gibbs free energy, the Laplace pressure (Δp) decreases as the radius of the particle increases. Accordingly, two solder particles can be easily combined to form a larger particle, thereby decreasing the internal Laplace pressure. It is therefore believed that the high Laplace pressure within smaller molten solder particles causes them to be further attracted to the spreading molten solder, which has a relatively lower internal Laplace pressure. Furthermore, as known to those of skill in the art, fluxing generally occurs from higher pressure to lower pressure.

The self-organizing solder paste of the invention may be used on a variety of substrates and with a variety of metal bumps. For instance, the solder paste may be used on organic package substrates and motherboards, ceramic package substrates and motherboards, and on silicon substrates. In further implementations, other types of substrates not mentioned here but known in the art may be used with the solder paste of the invention.

At least one of the substrates includes metal bumps formed on its surface. Any metal bumps may be used as long as the melting temperature of the metal is higher than the temperatures used during the chip attachment process (e.g., the reflow temperature). A metallic surface finish may be used on the metal bump structures to prevent surface contamination and to improve solder wetting. Examples of such metallic surface finishes include gold, gold-nickel alloys, silver, and tin.

Examples of metal bumps that may be used include stud bumps, balls, wires, microvias, and metal pads. The shape of the metal bumps may vary depending on the specific application in which they are used or formed. FIG. 5 illustrates several metal bump configurations that can easily contact moving solder particles within the solder paste of the invention during the chip attachment process described below. These structures include a rectangular bump, a plat or pad, a round bump, a tapered bump, and a conical bump. Alternate structures not shown here may also be used with the solder paste of the invention.

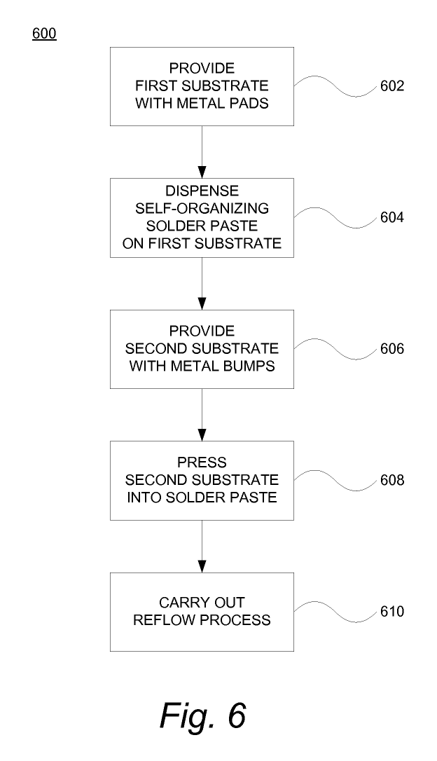

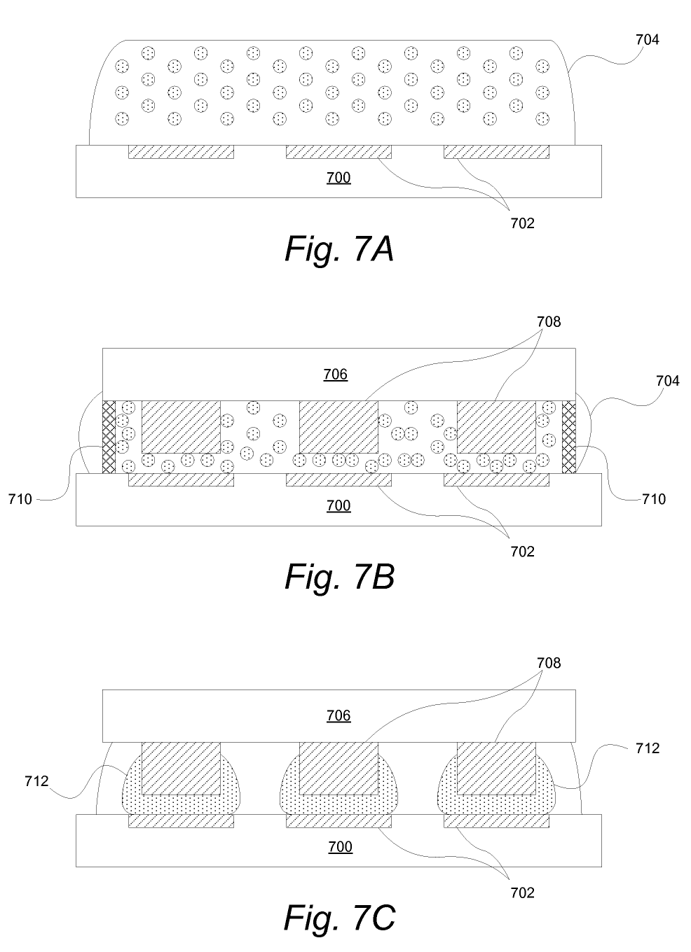

FIG. 6 is a chip attachment process 600 that forms an interconnection between metal pads on a first substrate and metal bumps on a second substrate in accordance with implementations of the invention. FIGS. 7A to 7C illustrate a first and second substrate being interconnected using the process described in FIG. 6.

The process 600 begins by providing a first substrate having an array of metal pads (process 602 of FIG. 6). The metal pads may be formed of any metal that is conventionally used to form metal pads such as copper. A self-organizing solder paste formed in accordance with implementations of the invention is then dispensed over the metal pads on the surface of the first substrate (604). A conventional dispenser module may be used. The volume of solder paste used may vary based on the size and density of the metal pads. In some implementations, the volume of solder paste applied may be sufficient to cause the solder paste to have a thickness between around 10 μm and around 100 μm. In implementations where the solder paste is applied over metal bumps, the volume of solder paste that is applied may be sufficient to cause the solder paste to have a thickness that is at least two times the height of the metal pads. In various implementations of the invention, the dispensing volume of the solder paste should be optimized for its particular application. If excess solder paste is applied, it may be removed after reflow.

The solder paste is dispensed over the entire metal pad-containing surface of the first substrate without the use of masking and/or stencil techniques. In other words, a single, blanket layer of solder paste is formed on the first substrate that is substantially or completely continuous. FIG. 7A illustrates a first substrate 700 than includes metal pads 702 on its surface. As shown, a single, continuous, blanket layer of a self-organizing solder paste 704, formed in accordance with an implementation of the invention, is deposited over the metal pads 702.

The process 600 continues by providing a second substrate having an array of metal bumps to be interconnected with the first substrate (606). The metal bumps may be formed of any metal that is conventionally used to form metal pads such as copper. Next, the second substrate is pressed into the solder paste on the first substrate (608). The second substrate is oriented such that its metal bumps are within the solder paste and each metal bump is aligned with a corresponding metal pad on the first substrate. The second substrate is brought into close proximity with the first substrate, generally leaving a small gap between the metal bumps and their corresponding metal pads. In various implementations, this small gap may range from around 1 μm to around 50 μm. The gap provides space for the solder particles in the solder paste of the invention to self-organize into solder bumps between the metal pads and the metal bumps. The size of the gap controls the bond line thickness.

A conventional chip placing module may be used to join the second substrate with the first substrate. In some implementations, a spacer may be used to control the size of the gap between the metal pads and the metal bumps. By controlling the size of the gap, the spacer ensures space exists for the solder particles to form into solder bumps and the spacer controls the bond line thickness. FIG. 7B illustrates a second substrate 706 that has been pressed into the solder paste 704 for interconnection with the first substrate 700. As shown, metal bumps 708 of the second substrate 706 are aligned with metal pads 702 of the first substrate 700. Spacers 710 are used to control the gap between the metal bumps 708 and the metal pads 702.

Once the second substrate is properly positioned and aligned, a reflow process is carried out to melt the solder particles and allow them to self-organize into solder bumps (610). As mentioned above, during a reflow process, the temperature of the solder paste is elevated to a level that is above the melting point of the solder particles but below the melting point of the metal bumps and the metal pads. In implementations of the invention, the temperature of the reflow process may range from 100° C. to 500° C. and the reflow process may be carried out for a time duration that falls between around 30 seconds and 900 seconds.

In accordance with implementations of the invention, the time and temperature profile of the reflow process is controlled such that the solder particles melt and appropriately self-organize into solder bumps. The specific time and temperature profile used will depend on the composition of the solder particles in the solder paste of the invention and may further depend on the type of substrate used. In implementations of the invention, the peak reflow temperature will fall between around 100° C. and around 400° C. For lead-free solder particles, the peak reflow temperature will typically fall between around 200° C. and around 300° C. For specially designed low temperature, lead-free solder particles, including but not limited to BiIn, SnIn, BiInZn, SnInZn, SnBi, and SnZnIn, the peak reflow temperature will typically fall between around 100° C. and around 200° C. For specially designed high temperature, lead-free solder particles, including but not limited to SnAu, ZnSn, and AlSn, the peak reflow temperature will typically fall between around 300° C. and around 500° C. The substrate materials used will depend on their ability to withstand the temperatures used during the reflow process, and include materials such as silicon, ceramic, and organic substrates.

In implementations of the invention, the time duration of the reflow process may range up to 15 minutes or longer, depending on the specific composition of the solder particles and the type of substrate used. For lead-free solder particles, the time duration will typically fall between around 3 minutes and around 10 minutes. For specially designed low temperature, lead-free solder particles, the time duration will typically fall between around 0.5 minutes and around 5 minutes. And for high temperature, lead-free solder particles, the time duration may range up to 15 minutes or more.

In some implementations, the temperature of the solder paste may be varied over the time duration, for instance, the temperature may be slowly elevated until it reaches a peak temperature. In further implementations, after reaching the peak temperature, the solder temperature may then be slowly decreased until the end of the time duration. The time and temperature profile used in implementations of the invention tend to minimize or prevent to formation of solder bridges between adjacent metal pads.

As shown in FIG. 7C, during reflow, the solder particles in the solder paste 704 coalesce onto the metal bumps 708 and the metal pads 702 to form solder bumps 712 within the area proximate each metal bump 708 and pad 702. The solder bumps 712 therefore form a discrete interconnection between each metal bump 708 and its corresponding metal pad 702. And unlike the prior art, the solder bumps 712 are not pre-formed over the metal bumps 708 or over the metal pads 702 prior to the two substrates 700/706 being interconnected, as is the case in the prior art.

The non-solder materials of the solder paste may then be evaporation or they may remain on the solder bump after reflow, as shown in FIG. 7C. Remaining chemical residues may be removed by cleaning if needed.

In implementations where a mixture of solder particles with different compositions is used, a reflow temperature should be chosen that is higher than the melting point of at least one of the compositions. When the solder particles of at least one composition are molten, they are able to form alloys having much lower melting temperatures. For example, when molten tin solder particles (with a melting point of 232° C.) contact solid sliver solder particles (with a melting point of 961° C.), a SnAg eutectic alloy having a melting temperature of 221° C. may be formed.

A substantial percentage of the solder particles in the solder paste are used in forming the solder bumps. In some implementations, substantially all of the solder particles in the solder paste are used in forming the solder bumps.

It should be noted that in alternate implementations, the self-organizing solder paste may be initially deposited on the second substrate having the metal bumps. The first substrate having the metal pads may then be brought into contact with the solder paste to form interconnections with the second substrate.

Accordingly, an in-situ chip attachment process using a self-organizing solder paste has been disclosed. The self-organizing solder paste of the invention couples interconnect structures having a fine pitch of 100 μm or less without pre-solder bumping. The chip attachment process described herein simplifies the chip attachment process by eliminating the need for masking or stenciling processes, thereby providing a significant cost reduction for various applications.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A method comprising:
dispensing a solder paste on a first substrate having at least one metal pad, wherein the solder paste comprises:
an organic flux, and
solder particles dispersed in the organic flux;
pressing a second substrate having at least one metal bump into the solder paste such that the at least one metal bump is aligned with the at least one metal pad of the first substrate; and
heating the solder paste to a reflow temperature for a time duration sufficient to cause the solder particles to coalesce onto the metal pad and the metal bump, thereby electrically coupling the metal pad to the metal bump.

2. The method of claim 1, wherein the reflow temperature is between around 100° C. and around 500° C.

3. The method of claim 1, wherein the time duration is between around 30 seconds and around 900 seconds.

4. The method of claim 1, wherein a gap remains between the at least one metal bump and the at least one metal pad when the second substrate is pressed into the solder paste.

5. The method of claim 1, wherein the solder particles have a mean diameter that falls between around 0.1 μm and around 10 μm.

6. The method of claim 1, wherein the metal pad comprises copper metal.

7. The method of claim 1, wherein the metal bump comprises copper.

8. The method of claim 1, wherein the organic flux comprises a synthetic resin.

9. The method of claim 1, wherein the solder particles comprise a base metal and an alloying metal.

10. The method of claim 9, wherein the base metal is selected from the group consisting of tin, indium, bismuth, and zinc.

11. The method of claim 9, wherein the alloying metal is selected from the group consisting of copper, nickel, cobalt, silver, gold, titanium, aluminum, lanthanum, cerium, iron, manganese, gallium, germanium, antimony, tantalum, and phosphorous.

12. The method of claim 1, wherein the weight percent (wt %) of solder particles in the solder paste falls between around 10 wt % and around 50 wt %.

13. The method of claim 1, wherein the first substrate includes a plurality of metal pads and wherein the dispensing of the solder paste comprises dispensing a single, continuous layer of solder paste on the plurality of metal pads.

14. A self-organizing solder paste comprising:
an organic flux comprising a synthetic rosin; and
a plurality of solder particles having a mean diameter that falls between around 0.1 μm and around 10 μm, wherein the solder particles comprise a base metal and an alloying metal, wherein the base metal is selected from the group consisting of tin, indium, bismuth, and zinc, and wherein the alloying metal is selected from the group consisting of copper, nickel, cobalt, silver, gold, titanium, aluminum, lanthanum, cerium, iron, manganese, gallium, germanium, antimony, tantalum, and phosphorous.

15. The solder paste of claim 14, wherein a weight percent (wt %) of solder particles in the solder paste falls between around 10 wt % and around 50 wt %.

16. The solder paste of claim 14, wherein the solder particles comprise a first set of solder particles and a second set of solder particles, wherein the base metal used in the first set of particles is different than the base metal used in the second set of particles.

17. A method comprising:
depositing a solder paste on a first substrate having a first metal structure, wherein the solder paste comprises:
an organic flux comprising a synthetic resin, and
solder particles dispersed in the organic flux, wherein the solder particles have a mean diameter that falls between around 0.1 μm and around 10 μm;
pressing a second substrate having a second metal structure into the solder paste such that the second metal structure is aligned with the first metal structure and a gap exists between the first and second metal structures; and
heating the solder paste to a reflow temperature for a time duration sufficient to cause the solder particles to coalesce and form an electrical connection between the first and second metal structures.

18. The method of claim 17, wherein the reflow temperature is between around 100° C. and around 500° C.

19. The method of claim 17, wherein the time duration is between around 30 seconds and around 900 seconds.

20. The method of claim 17, wherein the solder particles have a mean diameter that falls between around 0.1 μm and around 5 μm.

21. The method of claim 17, wherein the first metal structure comprises a metal pad and the second metal structure comprises a metal bump.

22. The method of claim 17, wherein the first metal structure comprises a metal bump and the second metal structure comprises a metal pad.

23. The method of claim 21, wherein the metal bump comprises a structure selected from the group consisting of a rectangular bump, a plat, a round bump, a tapered bump, a conical bump, a stud bump, a ball, a wire, and a microvia.

24. The method of claim 22, wherein the metal bump comprises a structure selected from the group consisting of a rectangular bump, a plat, a round bump, a tapered bump, a conical bump, a stud bump, a ball, a wire, and a microvia.

25. The method of claim 17, wherein the solder particles comprise a base metal and an alloying metal.

26. The method of claim 25, wherein the base metal is selected from the group consisting of tin, indium, bismuth, and zinc.

27. The method of claim 25, wherein the alloying metal is selected from the group consisting of copper, nickel, cobalt, silver, gold, titanium, aluminum, lanthanum, cerium, iron, manganese, gallium, germanium, antimony, tantalum, and phosphorous.

28. The method of claim 25, wherein the weight percent (wt %) of solder particles in the solder paste falls between around 10 wt % and around 50 wt %.

29. The method of claim 17, wherein the first substrate includes a plurality of first metal structures and wherein the depositing of the solder paste comprises depositing a single, continuous layer of solder paste on the plurality of first metal structures.

30. The method of claim 29, wherein the second substrate includes a plurality of second metal structures and wherein the pressing of the second substrate into the solder paste comprises pressing the second substrate into the single, continuous layer of solder paste such that the plurality of second metal structures are aligned with the plurality of first metal structures.
